(19) United States
(12) Patent Application Publication
(10) Pub. No.: US 2002/0132662 A1
(43) Pub. Date: Sep. 19, 2002

(54) Micro-payment method and system

(75) Inventors: Christopher Edward Sharp, Winchester (GB); Andrew James Stanford-Clark, Chale (GB)

Correspondence Address: IBM Corp, IP Law Dept T81/503,, 3039 Cornwallis Road,, P.O. Box 12195,, Research Traingle Park, NC, 27709-2195, US

(73) Assignee: International Business Machines Corporation

(21) Appl. No.: 10/041,329

(22) Filed: Jan. 3, 2002

(30) Foreign Application Priority Data
Mar. 17, 2001 (GB) 0106698.4

(51) Int. Cl. A63F 13/00

(52) U.S. Cl. 463/25; 463/29; 463/42; 700/91

(57) ABSTRACT

A known micro-payment system suffers from a problem of needing increasing network bandwidth as the granularity of the micro-payment decreases, thus increasing the latency of the processing of each micro-payment. The present system seeks to address this problem. There is disclosed a method, performed in an interactive client server system, of charging micro-payments to a third party billing server on behalf of a user using the interactive client server system, said method comprising the steps of: requesting a billing authorization from a user of the interactive client server system; receiving an authorization including an address of a billing server (e.g. from a smart card); sending an authorization message to the billing server. The billing server determines from the authorization whether the user has a valid account at the billing server. A micro-payment value may be determined from the authorization. The interactive client server receives confirmation that authorization is acceptable to the billing server together with the micro-payment value. It then generates, on condition of a confirmed authorization, charge events having an associated charge in monetary terms. It then sums the charge for the charge events until the micro-payment value has been reached and sends the charge summation to the billing server to be debited from the user's account as a micro-payment. In this way finer granularity of micro-payment is achieved without increasing bandwidth use.

### FIELD OF INVENTION

This invention relates to a micro-payment method and system for use in a network environment such as the internet. In particular it describes a continuous micro-payment framework within a distributed interactive client-server system such as an interactive entertainment system.

### BACKGROUND OF THE INVENTION

Many client-server systems available on the internet have information which they sell to a customer. The customer will log on to the information provider, request some information, and provide payment details such as a credit card which is debited while the customer downloads the information.

Not all client systems can use this charging model. Interactive online systems allow a participant to interact with a server but there is no one piece of information that can be charged to the customer and different methods are used.

One form of charging for this online system is by subscription. A subscription payment model is advantageous for the provider as payments and revenue are easy to calculate. One off payments are simple to collect by the provider and pay by the subscriber. However it can be expensive for some players who might not use the system as much as others.

Another form of payment model are micro-payments. As the name suggests many small payments are paid over a period rather than one single payment in the period.

One of the drawbacks of micro-payments is that for each payment a transaction between the client and server must be made to verify and authorise the payment. A transaction will always have a cost associated with it to process it. This cost must always be less than the value of the transaction, otherwise the processing cost is prohibitively expensive. Also, in large interactive client-server systems this constant interaction of authorisation and transaction exchange can produce an unnecessary burden on the network and the efficiency and latency of the micro-payment is restricted by the bandwidth of the network so that there effectively exists a minimum micro-payment size. Therefore for small payments smaller than the minimum micro-payment there exists no method of payment which will not burden the network.

A known internet micro-payment system is Jalda launched through a joint venture of Ericsson and Hewlett-Packard. It is a secure internet payment method that enables payments from stationary PCs, mobile phones or any other communication device with Internet access, turning these machines into portable payment terminals. It works by an account-based system that associates every user with a specific account. It enables customers to be charged by whatever parameter the electronic commerce provider desires and each charge is authorized using digital certificates and RSA Public Key Infrastructure encryption.

The Jalda model requires all invocations of the charging mechanism (a “tick”) to be processed and authorized by the payment server. This means a round trip from client to payment server for each tick. This is not realistic in a video game scenario, where latency is crucial.

The Jalda model requires the client API (the code sitting in the application local to the user) generates the charging “ticks”. Firstly, this requires the content provider to entrust all of his revenue generation to his client application, but this is susceptible to client “hacking” to remove the charging mechanisms. Our model provides the option for either client or server invocation of the charging mechanism, as the server application has been granted the right to charge up to a certain amount by the billing server already. This is required by content provider services, such as online games, where they cannot guarantee the integrity of the clients connecting to them.

There is room for a system that would allow service providers to charge at a much finer granularity of access, enabling them to control their revenue streams further and create more attractive packages for their customers without introducing prohibitive latency associated with the transaction that would affect the performance of the interactive system. It will also allow continuous charging with minimal (and controllable) interaction with the consumer.

### DISCLOSURE OF THE INVENTION

One aspect of the present invention provides a micropayment method, as described in the claims.

Another aspect of the present invention provides an interactive client server system for charging micropayments as described in the claims.

Another aspect of the present invention provides a computer program micropayment as described in the claims.

Our model uses a pre-authorisation mechanism, where the payment server gives the content provider a credit token which permits the content provider to charge up to a consumer defined amount without re-authorisation. This way, the “ticks” can be batched by the content provider, rather than the payment server, reducing network traffic/latency.

Advantageously the method further comprises:receiving a re-authorization limit from the billing server; summing the charge events until the re-authorization limit is reached; cancelling the authorization; sending the charge summation to the billing server to be debited from the user's account as a micro-payment; and re-requesting billing authorization from the user.

More advantageously the method further comprises: receiving a credit limit from the billing server; summing the charge for the charge events until the credit limit value is reached; sending the charge summation to the billing server to be debited from the user's account as a micro-payment; cancelling the authorization; and disabling the billing authorization.

The preferred embodiment consists of continuous-micro-payment-client (cMPC) code and continuous-micro-payment-server (cMPS) code, an authentication system and billing server. The software developers of interactive entertainment systems use the cMPC and cMPS code libraries and API to facilitate transactions in arbitrary ways within the specific application, and the semantics of the transaction are defined at the application level.

This application defined semantics facilitates the charging of services of an arbitrary nature, for downloadable software, for access to facilities within the software, or for sustained access on a temporal basis (e.g. pay-per-click or pay-per-view or pay-per-minute).

Some contract exists between the authentication system and the billing server such that the identification supplied by the authentication system corresponds to an account on the billing server. Typically, this means a unique account number for a user. The supplied authentication must map to a unique (for that billing server) private key that corresponds to the account number. The authentication means could be one of many possibilities (e.g. a smartcard containing the signature and key, supplied by the billing server owner; a userid/password protected dialog to access the signature, a mobile phone SIM card or WAP service, etc.)

When the player starts the client code (local game code) it invokes the local cMPC, which requests authentication from the authentication system. The source of authentication could be a one-time setup at installation of the game, or dynamically located by the cMPC by querying the underlying operating system etc.

The output from the authentication system is a digital signature (based on the current time, encrypted with the private key), and billing server location.

When the user connects to the interactive service, the servers cMPC will request authentication from the players MPC.

The local cMPC will respond with the digital signature and billing server location.

The server cMPC will now contact the cMPS located at the users billing server to request authentication of the digital signature and authorisation to charge to the players account associated with this signature. The cMPS will respond with either positive or negative authorisation, and a micro-payment value. micro-payment value allows the server cMPC to charge the cMPS up to a specified amount. This amount has been agreed by the account owner on setup of the account. Positive authorisation will be granted by the cMPS if the signature, when decrypted with the billing servers key, identifies an account with the Billing server and a current time.

If positive authorisation has been granted, the game may continue. The interactive client/server will define the various metrics associated with transactions within the semantics of the interaction e.g. value of a single charge, whether there will be static time-driven charges for connect time, handled by the server etc. Then as the interaction is progressed, the code at either the client or server end may call its cMPC to invoke a charge for a given value. If the client code invokes the charge, the client cMPC will communicate the charge to the server cMPC, acting as a proxy to the client cMPC. If the server code invokes a charge, it will communicate directly with its own cMPC. The server cMPC will communicate with the Billing servers cMPS to make debits to the users account, either interactively, or in a batch of charges equal to or less than the cMPS supplied debit limit.

The charges will be of any given monetary value, in the currency of the interactive server. If the users account, or the billing server, has a different currency, a currency conversion for the summed charge amount must occur, at the billing server where the transaction is lodged.

The cMPS will keep a record of charges, and when the charges reach the debit limit, the cMPS will communicate with the cMPC of the game server to indicate the debit limit has been reached for this signature. The MPC will now require a new debit limit, and need to request authentication again. If the user has configured his authentication system to automatically reply to the local cMPC without intervention, then a new signature will be generated for the cMPC and sent back to the server cMPC, otherwise, the interaction will be interrupted for action by the user to re-authorise.

One advantage of this system is that the game code (both client and server) does not have direct access to the users authentication system, only via the cMPC code. The game code only handles a pre-encrypted signature, and the encryption/decryption is handled by the authentication system/billing server of the user. The issue of debit limits defined by the user reduces latency and interruption in the game.

The interactive code is the mechanism for invoking and controlling transactions. The players MPC need only be communicated with when a new signature is required. The interactive server code can invoke transactions autonomously, but not exceeding the credit token limit.

The user's cMPC and authentication system never needs to communicate directly with the user's billing server. This allows the system to work on proprietary and closed networks, point-to-point services, “walled-gardens” etc, so long as the game service provider has communication access to the billing server.

For example, in a multi-player game involving weapons, the system could charge the player for the amount of ammunition used, or in a driving game, the amount of fuel. In an adventure game the player could be charged for the time spent playing down to the second In one embodiment of the present invention the billing server address is provided by the interactive client. In another embodiment the interactive client provides a reference to the billing server and the interactiver server resolves the reference using a reference/address look up table stored on the interactive server.

### BRIEF DESCRIPTION OF THE DRAWINGS

Various aspects of the inventions will now be described with reference to, by way of example only, embodiments shown in the figures in which:

FIG. 1 shows the architecture and message flow in the embodiment of the continuous micro-payment system;

FIG. 2A is a component diagram of a micro-payment client;

FIG. 2B is a component diagram of a micro-payment server; and

FIG. 3 is a flow diagram of the process steps of the embodiment.

### DESCRIPTION OF THE PREFERRED EMBODIMENT

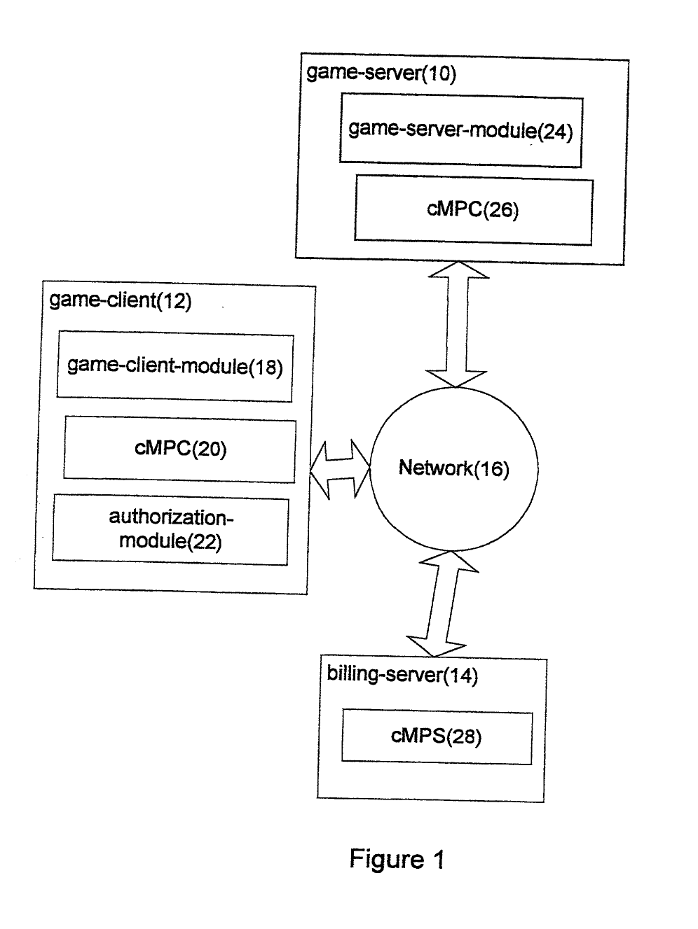

Referring to FIG. 1 there is shown the preferred embodiment (eplay) of the invention comprising a game-server (10), a game-client (12) and a billing-server (14) connected through a network (16).

The game-client (12) comprises a workstation such as IBM NetVista having a Intel Pentium III microprocessor running at 766 Mhz, 256 Kbytes L2 cache, 128 Mbytes of NP SDRAM, an Ultra ATA 66 20 Gbyte hard-drive, 48× CDROM, 10/100 Ethernet network interface and using Microsoft Windows Millennium Edition. However any equivalent workstation could perform the invention. In operation the game-client (12) comprises a game-client-module (18), a continuous-micro-payment-client (20) (cMPC) and an authorization-module (22).

The game-server (10) comprises a server such as an IBM Netfinity having an Intel Pentium III microprocessor running at 1000 Mhz, 256 Kbytes L2 cache, 4096 Mbytes of SDRAM, 220 Gbyte hard-drive, 10/100 Ethernet network interface and using Microsoft Windows NT. However any server could perform the invention. In operation the game-server (10) comprises a game-server-module (24) and a continuous-micro-payment client (26) (cMPC).

The billing-server (14) comprises similar hardware to the game-server (10) hardware. In operation the billing server comprises a continuous-micro-payment-server (28) (cMPS).

Netvista and Nefinity are a trademark of IBM Corporation. Intel and Pentium are Trademarks of Intel Corporation. Windows is a Trademark of Microsoft Corporation.

The game-client-module (18) and the game-server-module (24) provide the interactive service. In this embodiment the interactive service is an adventure game in which the user's on-screen character has to wander round a maze picking up treasure, avoiding booby traps and killing monsters. The user's character has a weapon which uses chargeable ammunition so that when the character uses the weapon the user is charged for the ammunition used. Each shot of the weapon is a chargeable-event and this chargeable-event occurs in the game-client so that the cMPC (20,26) can register it. Other events in the game may also be chargeable-events such as being damaged by a monster. Other events may be creditable events such as finding treasure.

A continuous-micro-payment-client (20,26) is situated on both the game-client (12) and the game-server (10). Although many of the operations are executed on the game-client (12) it is the game-server (10) which is in overall control of the execution. For instance, the game-client-module (18) may execute only when the game-server cMPC (26) is satisfied that the user is authorized and that charges can be made.

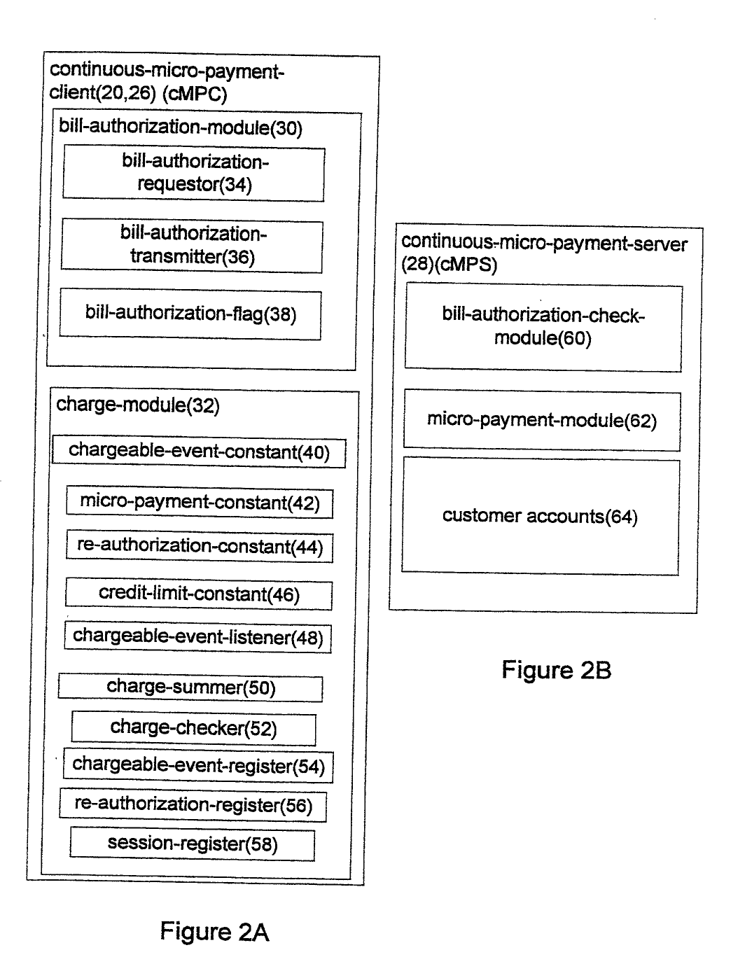

The continuous micro-payment client (20,26) (cMCP) and continuous-micro-payment-server (28) (cMSP) will now be described with reference to FIG. 2.

The cMCP (20,26) comprises two main modules:

a bill-authorization-module (30) and a charge-module (32).

The bill-authorization-module (30) comprises:

a bill-authorization-requestor (34);

a bill-authorization-transmitter (36) and bill-authorization-flag (38).

The bill-authorization-requestor (34) is responsible for requesting from the user an authorization to use the interactive service. This takes the form of a smart card which is inserted into a reader so that authorization information (user name and password, certificate and billing server address or reference) can be extracted. The user may also be asked to confirm his password. The bill-authorization-transmitter (36) is responsible for sending the authorization information to the billing-server (14). The information is sent to the game-client (12) to the game-server (10) and forwarded to the billing-server (14). Alternatively the information is sent from the game-server (10) and the billing-server (14) simultaneously. The bill-authorization-flag (38) is set when the authorization information is checked and verified by the billing-server (14). Normally the game-server (10)'s bill-authorization-flag (38) will be the controlling flag because it will be less prone to tampering by a user.

The charge-module (32) comprises: a chargeable-event-constant (40), a micro-payment-constant (42), a re-authorization-constant (44), credit-limit-constant (46), a chargeable-event-listener (48), a charge-summer (50), a charge checker (52), a chargeable event register (54), a re-authorization-register (56) and a session register (58).

The constants are values held in register, variables or the like. The chargeable-event-constant (40) is loaded with the value, in money terms of the chargeable-event. This information is acquired from the game-server-module (24) or game-client-module (18). In this embodiment there is only one chargeable-event but in other embodiments there may be more than one chargeable event so several chargeable-event-constants would be needed. The micro-payment-constant (42) is loaded with the value, in money terms, of the amount of total charge that when reached will be requested from the billing-server (14). This information may be acquired from the game-server-module (24), game-client-module (18) or the billing-server (14). The re-authorization constant (44) is loaded with the value, in money terms, of the amount of total charge which when reached in a session triggers a bill authorization from the user. In other embodiments this constant may be simply the amount of times the micro-payment may be made before re-authorization. The credit-limit-constant (46) is loaded with the value, in money terms, of the amount of total charge which when reached in a session terminates the session without a re-authorization. To reset the credit limit further action is required such as paying the account with the billing server.

The chargeable-event-listener (48) listens for chargeable events that occur in the game-client-module (18) and forwards such events to charge-summer (50).

The chargeable-event-register (54) is the register which contains the cumulative charge since the last micro-payment was made, once the next micro-payment is made then this register is reset to zero. The re-authorization-register (56) contains the total charge since that authorization. Once this register is equal or more than the re-authorization-constant (44) then re-authorization is requested. In other embodiments the register may be incremented each time a micro-payment is made and re-authorization-constant (44) is an integer representing the number of times micro-payments may be made before re-authorization. The session-register (58) contains the total charge for the session. Once a interactive session is finished then this register is reset to zero. This register is checked against the credit limited constant.

The charge-summer (50) receives events from the chargeable-event-listener (48). It checks the chargeable event against the event constant and adds the appropriate amount to the chargeable-event-register (54) and session-register (58). The charge-summer (50) matches the event with the particular event constant if there is more than one chargeable-event.

The charge-checker (52) checks the chargeable-event-register (54), if it is equal to or more than the micro-payment-constant (40) then a micro-payment is requested. The charge-checker (52) also checks the re-authorization-register (56), if it is equal to or more than the re-authorization-constant (44) then a re-authorization request is made and the re-authorization-register (56) is reset to zero. The charge-checker (52) also checks the session-register (58), if it is more than or equal to the credit-limit-constant (40) then a micro-payment is requested and an end of session is initiated. If authorization is tried straight away then the billing-server (14) will show that the user has a zero credit limit and no session will be allowed.

The continuous-micro-payment-server (28) (cMPS) comprises: a bill-authorization-check-module (60), a micro-payment-module (62) and customer accounts (64).

The bill-authorization-check-module (60) checks authorization information acquired from the client against information held in the customer accounts (64). The authorization information is passed to the bill-authorization-check-module (60) by the bill-authorization-transmitter (36) in the cMPC (20,26).

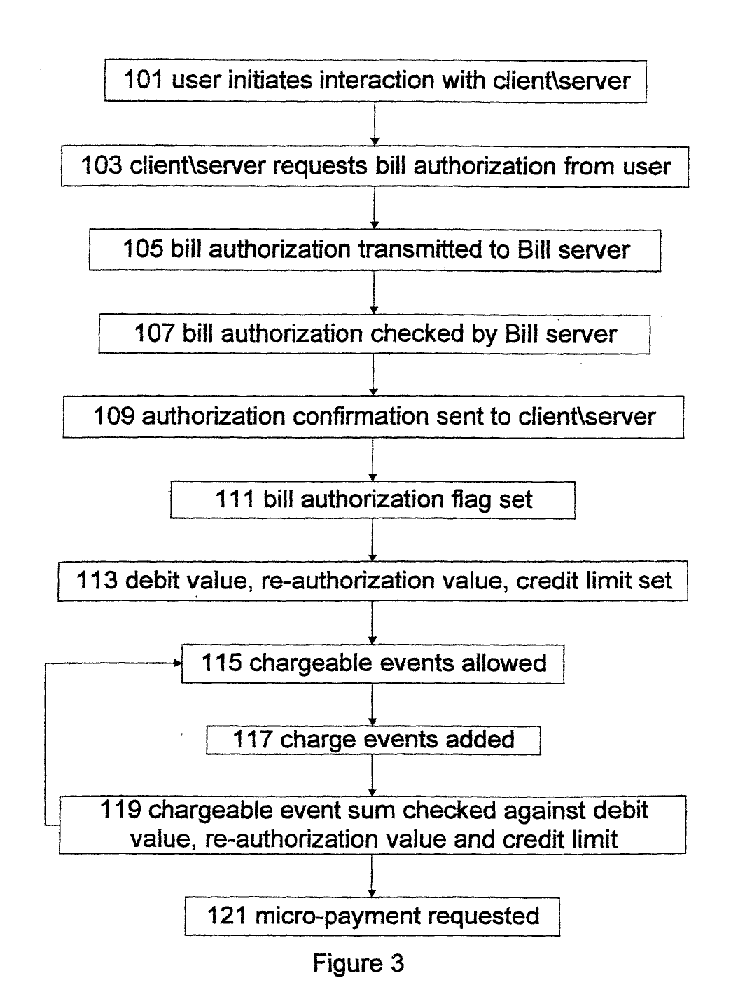

The method of the present embodiment will now be described with reference to the flow diagram of FIG. 3.

The user initiates (step 101) interaction with the game-client (12) by starting the game on their local machine. The game-client (12) then contacts the game-server (10). The game-server (10) completes the session to control the interaction.

The game-client (12) then initiates a request (step 103) of authorization from the user using the bill-authorization-requestor (34). The user, by means of a smart card plugged into the client terminal, passes over an identification and password. A contract exists between the bill-authorization-module (30) and a billing-server (14) such that the identification supplied by the authorization-module (22) corresponds to an account on that particular billing-server (14). Typically the identification is a unique account number for a user on a particular billing-server and the supplied authentication must map to a unique (for that billing server) password key that corresponds to the account number.

The identification comprises the user account number and also a reference to the billing server. In the preferred embodiment the reference to the billing server is a pointer which is resolved by the interaction server into an address. The reference can be something as simple as a test string containg the company name. The advantage of this system is that the actual billing service provider implementation details can change over time without affecting the user. This reference can then be used by the mircropayment system as the parameter to a search request to a universal directory service, such as that provided on the internet in the form of the UDDI registry. This UDDI registry stores the billing service providers service implementation details in the form of a WSDL (Web Service Description Language) document, defining the location of the service and other interaction details.

In an alternative embodiment the identification comprises the address of the billing server e.g. As an I.P address.

The bill-authorization-transmitter (36) then passes (step 105) the authorization information to the bill-authorization-check-module (60) in the billing-server (28).

The bill-authorization-check-module (60) checks (step 107) the identification in the authorization information with customer accounts (64). It retrieves a matching account along with password and checks the retrieved password with the password contained in the authorization information, and confirms the signature of the certificate.

If the identification is confirmed then authorization sent (step 109) to the game-client (12) and game-server (10).

The bill-authorization-flag (38) is set (step 111).

The micro-payment-constant (42), re-authorization constant (44), credit-limit-constant (46) are set (step 113) according to values in the matched customer account (64).

Once the bill-authorization-flag (38) is set the game-client-module (18) starts the interactive service in which chargeable-events may be generated (step 115).

Each chargeable-event that the chargeable-event-listener (48) picks up is passed on to the charge-summer (50) so that the appropriate amount is added (step 117) to the chargeable-event-register (54), the re-authorization-register (56) and the session-register (58).

The charger-checker (52) then checks (step 119) the chargeable-event-register (54) against the micro-payment-constant (42), the re-authorization-register (56) against the re-authorization-constant (44) and the session-register (58) against the credit-limit-constant (46). In each case if the register is equal to or more than the constant a micro-payment is requested (step 121).

In this embodiment the software is an adventure game but any other game in which an event can be made a chargeable event would be suitable. For instance any type of ‘shoot-em-up’, ‘beat-em-up’, driving, simulator, or platform game could be an embodiment and any event in the game could be charged (e.g. the shots, blows, time or fuel used).

In this embodiment the game-client (12) and game-server (10) are operating on separate machines and connected by internet using standard internet protocols such as http or https. However in other embodiments the client-server may be on the same machine for instance on an arcade machine.

In other embodiments a smart card may not be used but certificate stored on the users computer may be located.

The UDDI service and protocol is defined as an open standard by the UDDI consortium (UDDI org) and the WSDL document format is defined as an open standard by the W3C (www.W3.org).

What is claimed is:

1. A method, performed in an interactive client server system, of charging micro-payments to a third party billing server on behalf of a user using the interactive client server system and having an account on the third part billing server, said method comprising the steps of:
requesting a billing authorization from a user of the interactive client server system;
receiving an authorization including reference to a billing server;
sending an authorization message to the billing server at the received address;
receiving confirmation from the billing server that authorization is acceptable together with a micro-payment limit;
generating, on condition of a confirmed authorization, charge events having an associated charge in monetary terms;
summing the charge for the charge events; and
when the summed charge reaches the micro-payment limit, sending the charge summation to the billing server to be debited from the user's account as a micro-payment.

2. A method as claimed in claim 1 further comprising:
receiving a re-authorization limit from the billing server;
summing the charge events until the re-authorization limit is reached;
cancelling the authorization;
sending the charge summation to the billing server to be debited from the user's account as a micro-payment; and
re-requesting billing authorization from the user.

3. A method as claimed in claim 2 further comprising:
receiving a credit limit from the billing server;
summing the charge for the charge events until the credit limit value is reached;
sending the charge summation to the billing server to be debited from the user's account as a micro-payment;
cancelling the authorization; and
disabling the billing authorization.

4. A method as claimed in claim 3 whereby the billing server determines the micro-payment limit from the user's account details.

5. A method as claimed in claim 4 whereby the interactive client server system supplies the micro-payment limit.

6. A method as claimed in claim 5 wherein the interactive client requests the billing authorization.

7. A method as claimed in claim 6 wherein the interactive client receives the authorization.

8. A method as claimed in claim 7 wherein the interactive client sends the authorization to the billing server.

9. A method as claimed in claim 8 wherein the interactive server and client receive confirmation of the accepted authorization.

10. A method as claimed in claim 9 wherein the interactive client generates charging events.

11. A method as claimed in claim 10 wherein the interactive server sums the charge.

12. A method as claimed in claim 11 wherein the interactive server sends the charge summation to the billing server.

13. A method as claimed in claim 12 wherein a charge event is initiated by a user controlled input.

14. A method as claimed in claim 13 wherein the charge event is a clock input.

15. A method as claimed in claim 14 wherein said received authorization is a signature and key contained on a smart card.

16. A method as claimed in claim 15 wherein said received authorization is a signature accessed through a userid/password protected dialog.

17. A method as claimed in claim 16 wherein said charge event is of a plurality of charge events, each having different associated charge.

18. A method as in claim 1 wherein the reference to the billing server is the address of the billing server.

19. A method as in claim 1 wherein the reference to the billing server is resolved into the billing server address from a reference/address look up table.

20. A method as in claim 19 wherein the interactive server maintains the reference/address look up table and resolves the address.

21. An interactive client server system for charging micro-payments to a third party billing server on behalf of a user using the interactive client server system and having an account on the third part billing server, said system comprising:
means for requesting a billing authorization from a user of the interactive client server system;
means for receiving an authorization including reference to a billing server;
means for sending an authorization message to the billing server at the received address;
means for receiving confirmation from the billing server that authorization is acceptable together with a micro-payment limit;
means for generating, on condition of a confirmed authorization, charge events having an associated charge in monetary terms;
means for summing the charge for the charge events; and
means for, when the summed charge reaches the micro-payment limit, sending the charge summation to the billing server to be debited from the user's account as a micro-payment.

22. A system as claimed in claim 21 further comprising:
means for receiving a re-authorization limit from the billing server;
means for summing the charge events until the re-authorization limit is reached;
means for cancelling the authorization;
means for sending the charge summation to the billing server to be debited from the user's account as a micro-payment; and
means for re-requesting billing authorization from the user.

23. A system as claimed in claim 22 further comprising:
means for receiving a credit limit from the billing server;
means for summing the charge for the charge events until the credit limit value is reached;
means for sending the charge summation to the billing server to be debited from the user's account as a micro-payment;
means for cancelling the authorization; and
means for disabling the billing authorization.

24. A system as claimed in claim 23 whereby the billing server determines the micro-payment limit from the user's account details.

25. A system as claimed in claim 24 whereby the interactive client server system supplies the micro-payment limit.

26. A system as claimed in claim 25 wherein the interactive client requests the billing authorization.

27. A system as claimed in claim 26 wherein the interactive client receives the authorization.

28. A system as claimed in claim 27 wherein the interactive client sends the authorization to the billing server.

29. A system as claimed in claim 28 wherein the interactive server and client receive confirmation of the accepted authorization.

30. A system as claimed in claim 29 wherein the interactive client generates charging events.

31. A system as claimed in claim 30 wherein the interactive server sums the charge.

32. A system as claimed in claim 31 wherein the interactive server sends the charge summation to the billing server.

33. A system as claimed in claim 32 wherein a charge event is initiated by a user controlled input.

34. A system as claimed in claim 33 wherein the charge event is a clock input.

35. A system as claimed in claim 34 wherein said received authorization is a signature and key contained on a smart card.

36. A system as claimed in claim 35 wherein said received authorization is a signature accessed through a userid/password protected dialog.

37. A system as claimed in claim 36 wherein said charge event is of a plurality of charge events, each having different associated charge.

38. A system as in claim 24 wherein the reference to the billing server is the address of the billing server.

39. A system as in claim 24 wherein the reference to the billing server is resolved into the billing server address from a reference/address look up table.

40. A system as in claim 39 wherein the interactive server maintains the reference/address look up table and resolves the address.

41. A computer program product comprising computer program code stored in a computer readable storage medium for, when executed on a client server system, allowing the interactive client server system to charging micro-payments to a third party billing server on behalf of a user having an account on the third part billing server, the program code comprising:
means for requesting a billing authorization from a user of the interactive client server system;
means for receiving an authorization including reference to a billing server;
means for sending an authorization message to the billing server at the received address;
means for receiving confirmation from the billing server that authorization is acceptable together with a micro-payment limit;
means for generating, on condition of a confirmed authorization, charge events having an associated charge in monetary terms;
means for summing the charge for the charge events; and
means for, when the summed charge reaches the micro-payment limit, sending the charge summation to the billing server to be debited from the user's account as a micro-payment.

42. A computer program product system as claimed in claim 41 further comprising:
means for receiving a re-authorization limit from the billing server;
means for summing the charge events until the re-authorization limit is reached;
means for cancelling the authorization;
means for sending the charge summation to the billing server to be debited from the user's account as a micro-payment; and
means for re-requesting billing authorization from the user.

43. A computer program product system as claimed in claim 42 further comprising:
means for receiving a credit limit from the billing server;
means for summing the charge for the charge events until the credit limit value is reached;
means for sending the charge summation to the billing server to be debited from the user's account as a micro-payment;
means for cancelling the authorization; and
means for disabling the billing authorization.

44. A computer program product system as claimed in claim 43 whereby the billing server determines the micro-payment limit from the user's account details.

45. A computer program product system as claimed in claim 44 whereby the interactive client server system supplies the micro-payment limit.

46. A computer program product system as claimed in claim 45 wherein the interactive client requests the billing authorization.

47. A computer program product system as claimed in claim 46 wherein the interactive client receives the authorization.

48. A computer program product system as claimed in claim 47 wherein the interactive client sends the authorization to the billing server.

49. A computer program product system as claimed in claim 45 wherein the interactive server and client receive confirmation of the accepted authorization.

50. A computer program product system as claimed in claim 41 wherein the interactive client generates charging events.

51. A computer program product system as claimed in claim 50 wherein the interactive server sums the charge.

52. A computer program product system as claimed in claim 51 wherein the interactive server sends the charge summation to the billing server.

53. A computer program product system as claimed in claim 52 wherein a charge event is initiated by a user controlled input.

54. A computer program product system as claimed in claim 53 wherein the charge event is a clock input.

55. A computer program product system as claimed in claim 54 wherein said received authorization is a signature and key contained on a smart card.

56. A computer program product system as claimed in claim 55 wherein said received authorization is a signature accessed through a userid/password protected dialog.

57. A computer program product system as claimed in claim 56 wherein said charge event is of a plurality of charge events, each having different associated charge.

58. A computer program product system as in claim 41 wherein the reference to the billing server is the address of the billing server.

59. A computer program product system as in claim 41 wherein the reference to the billing server is resolved into the billing server address from a reference/address look up table.

60. A computer program product system as in claim 59 wherein the interactive server maintains the reference/address look up table and resolves the address.
